(19) United States
(12) Patent Application Publication
(10) Pub. No.: US 2002/0088787 A1
(43) Pub. Date: Jul. 11, 2002

(54) Contact tube for supplying current in the case of a welding torch

(76) Inventors: Hans-Guenther Ziegler, Spiegelberg (DE); Hilko Luettke, Esslingen (DE)

Correspondence Address: CROWELL & MORING, L.L.P., P.O. Box 14300, Washington, DC, 20044-4300, US

(21) Appl. No.: 09/978,781

(22) Filed: Oct. 18, 2001

(30) Foreign Application Priority Data
Oct. 18, 2000 (DE) DE 100 51 665.3

(51) Int. Cl. B23K 9/28

(52) U.S. Cl. 219/137.61

(57) ABSTRACT

A contact tube for supplying current in the case of a welding torch, having a tube body which contains a coaxial passage opening for a welding wire, the tube body containing a receiving opening coaxial to the passage opening, into which receiving opening at least one current transmission sleeve is inserted which consists of a material particularly suitable for transmitting current to the welding wire and which contains a coaxial passage which forms an axial section of the passage opening. Additionally, at least one guiding sleeve is inserted into the receiving opening, which guiding sleeve consists of a material particularly suitable for guiding the welding wire and which contains a coaxial passage which also forms an axial section of the passage opening.

This application claims the priority of German Patent Application DE 100 51 665.3, filed Oct. 18, 2000, the disclosure of which is expressly incorporated by reference herein.

### BACKGROUND OF THE INVENTION

The invention relates to a contact tube for supplying current in the case of a welding torch.

European Patent Document EP 0 399 334 A2, discloses a contact tube which has a tube body containing a coaxial passage opening for a welding wire. In this tube body, a receiving opening is constructed coaxially to the passage opening, into which receiving opening a current transmission sleeve is inserted which consists of a material particularly suitable for the current transmission and, in the case of the known contact tube, having a particularly high heat resistance and abrasion resistance. The current transmission sleeve is also provided with a coaxial passage which forms an axial section of the passage opening in the contact tube. In this case, this receiving opening starts at the exit of the welding wire so that the current transmission sleeve contains the exit of the welding wire.

European Patent Document EP 0 324 088 A1, discloses a contact tube into whose mouth area an insert is placed which is made of a spirally wound-up wire. This insert also consists of a heat-resistance and abrasion-resistant material which, in addition, has a suitable electric conductivity in order to ensure a sufficient current transmission to the welding wire.

German Patent Document DE 44 04 802 C1 disclose a contact tube for arc welding torches with a wire electrode. This contact tube consists of an outer layer made of copper or a copper alloy of high electric conductivity and of an inner layer with an increased resistance to wear. The inner layer has a matrix material with essentially the same composition and the same electric conductivity as the outer layer and into which particles are embedded. In addition, a boundary-surface-free bonding exists between the two layers.

German Patent Document DE 38 37 836 A1, discloses a contact tube produced from materials other than copper. In particular, it is suggested to construct the contact tube from electrically conducting ceramic materials. As a result of these measures, the sliding characteristics between the contact tube and the welding wire guided through the latter are to be improved.

The present invention relates to the problem of improving a contact tube of the initially mentioned type with respect to its durability or service life.

The invention is based on the general idea of integrating a current transmission sleeve as well as a guiding sleeve which is separate from the latter into the contact tube, the current transmission sleeve being optimized with respect to the selection of material for the current transmission to the welding wire, and the guiding sleeve being optimized with respect to the selection of material for a high heat resistance and a resistance to abrasion. In this manner, a functional separation takes place of the guiding characteristic from the current transmission characteristic of the contact tube. It is a special advantage in this case that materials can now also be used for the guiding sleeve which basically do not have to be electrically conductive. Particularly the electrically non-conductive materials include materials, such as ceramics, which are distinguished by a particularly high resistance to heat and to abrasion. On the other hand, when selecting the material for the current transmission sleeve, its resistance to abrasion no longer needs to be taken into account to such a high degree, so that now materials can also be used which are particularly well suited for the current transmission to the welding wire. On the whole, the durability or service life of the contact tube according to the invention can therefore be improved.

The invention is, among other things, also based on the recognition that, for implementing the welding operation, it is not necessary to contact the welding wire along the entire length of the contact tube. Correspondingly, particularly the guiding sleeve can be produced from an electrically non-conductive material. As a result of this measure, materials can therefore also be used now for producing a guiding sleeve which, on the one hand, have a particularly high-quality guiding characteristic, and more specifically, resistance to abrasion and/or heat, and which, on the other hand, because of their lack of electric conductivity, have not been previously used in a contact tube.

The current transmission sleeve may preferably consist of metal graphite or brush material or of a copper enriched with graphite or of a copper alloy enriched with graphite. These materials are distinguished by a particularly high electric conductivity.

In contrast, the guiding sleeve may consist, for example, of an electrically non-conductive ceramic material. Ceramics or ceramic materials are especially distinguished by a particularly high resistance to abrasion.

While the sleeves consist of relatively expensive special materials, the tube body itself can be produced from a relatively low-cost material. The tube body may, for example, consist of copper or of a copper alloy or of aluminum or of an aluminum alloy.

A particularly advantageous embodiment of the contact tube according to the invention is characterized in that the receiving opening starts at the entrance of the welding wire and ends in front of a mouth area of the tube body containing the exit of the welding wire, this mouth area containing a central opening whose cross-section is smaller than the cross-section of the receiving opening and forming an axial section of the passage opening. As a result of this measure, an annular step is formed at the exit-side end of the receiving opening, on which annular step the sleeve first fitted into the tube body comes to rest in an axial manner. In this case, this annular step radially overlaps the axial front face of the sleeve assigned to the exit and can thus shield the sleeve resting thereon against spatters occurring during the welding operation. Impairments of the sleeve material by spatters can therefore be avoided.

A maximal protective effect is achieved when the cross-section of the opening of the mouth area corresponds approximately to the cross-section of the passage of the sleeve adjoining it. The axial sections of the passage opening formed in the mouth area and the adjoining sleeve will then adjoin one another in an approximately flush manner.

Particularly long service lives can be achieved when the highly-stressable guiding sleeve is arranged very close to the exit of the welding wire. Correspondingly, in a preferred embodiment, the guiding sleeve may be arranged closer to the exit of the welding wire than the current transmission sleeve.

For improving the guiding effect, in another embodiment, one guiding sleeve respectively may be arranged in front of as well as behind the current transmission sleeve. In particular, one guiding sleeve will then be arranged at the exit and the other guiding sleeve will be arranged at the entrance of the welding wire, while the current transmission sleeve is arranged approximately in the center in the interior of the tube body.

According to an expedient embodiment, the sleeve arranged at the entrance of the welding wire can be equipped with an introducing funnel which facilitates the introduction or threading of the welding wire into the contact tube.

It is understood that the above-mentioned characteristics and those to be explained in the following can be used not only in the respectively indicated combination but also in other combinations or alone without leaving the scope of the present invention.

Preferred embodiments of the invention are illustrated in the drawings and will be explained in detail in the following description.

Other objects, advantages and novel features of the present invention will become apparent from the following detailed description of the invention when considered in conjunction with the accompanying drawings.

### BREIF DESCRIPTION OF THE DRAWINGS

FIG. 1 is a schematic lateral view, which is sectional in one half, of a contact tube according to the invention;

FIG. 2 is a schematic view of a second embodiment;

FIG. 3 is a schematic view of a third embodiment;

FIG. 4 is a schematic view of a fourth embodiment;

FIG. 5 is a schematic view of a fifth embodiment;

FIG. 6 is a schematic view of a sixth embodiment;

FIG. 7 is a schematic view of a seventh embodiment; and

FIG. 8 is a schematic view of a eight embodiment.

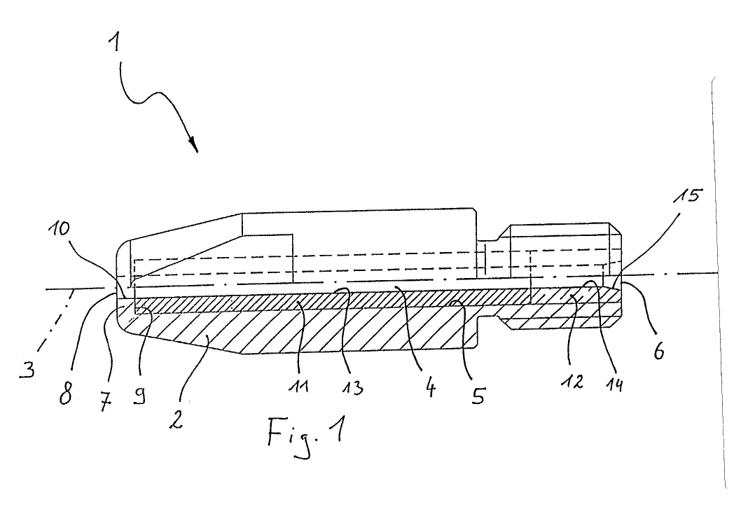

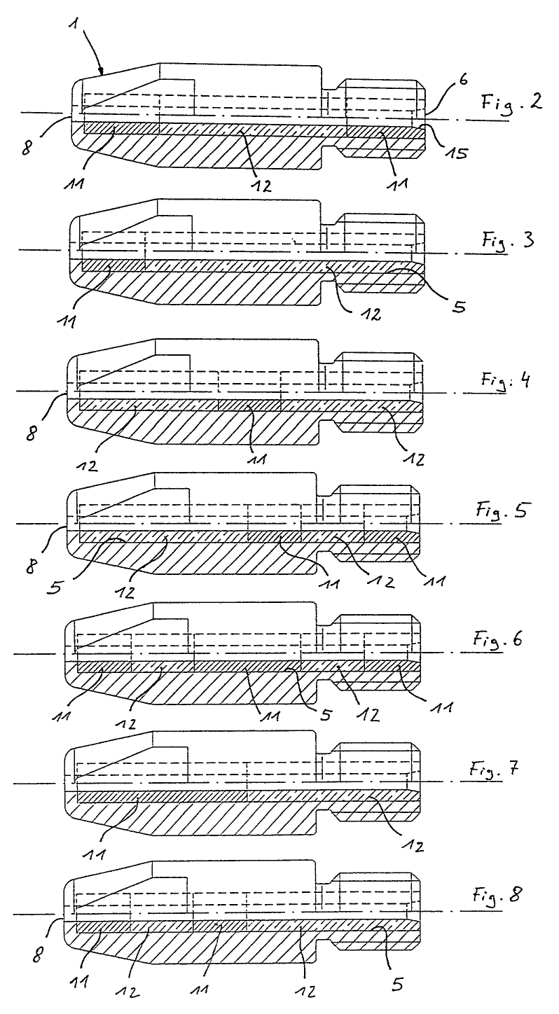

The important components of a contact tube according to the invention are shown in FIG. 1. Mutually corresponding components have the same reference numbers in the other embodiments of FIGS. 2 to 8.

In FIG. 1, a contact tube 1 according to the invention has a tube body which, for example, consists of copper or of a copper alloy, such as CuCrZr. A passage opening 4 is contained in the tube body 2 coaxially with respect to a longitudinal axis 3 of the tube body 2. Coaxially with respect to this passage opening 4, a receiving opening 5 is additionally constructed in the tube body 2, which receiving opening 5, in the embodiments illustrated here, always starts at an entrance 6 for a welding wire, which is not shown here, and ends in front of a mouth area 7 of the tube body 2 which contains an exit 8 for the welding wire. In this case, an annular step 9 is formed at the transition between the mouth area 7 and the receiving opening 5, which annular step 9 extends approximately radially toward the interior.

The mouth area 7 contains a central opening 10 whose cross-section is smaller than the cross-section of the receiving opening 5, this central opening 10 forming an axial section of the passage opening 4.

In the embodiment according to FIG. 1, a guiding sleeve 11 and a current transmission sleeve 12 are inserted into the receiving opening 5. The sleeves 11 and 12 are preferably pressed into the receiving opening 5 so that no additional fastening measures are required for fixing the sleeves 11, 112 in the tube body 2. The guiding sleeve 11 as well as the current transmission sleeve 12 each contain one coaxial passage 13 and 14 respectively which each form an axial section of the passage opening 4.

While the guiding sleeve 11 is made of a material, such as a ceramic material, which is particularly resistant to abrasion, the current transmission sleeve 12 consists of a particularly well-conducting electric conductor, such as metal graphite.

In the embodiment illustrated in FIG. 1, the guiding sleeve 11 is arranged closer to the exit 8 than the current transmission sleeve 12. In addition, in this embodiment, the guiding sleeve 11 extends over a relatively large axial section of the receiving opening 5, while the current transmission sleeve 12 takes up only a relatively small axial section of the receiving opening 5.

The sleeve 12 assigned to the entrance 6 is equipped with an introducing funnel 15 which simplifies the threading-in of the welding wire. In the embodiment of FIG. 1, the current transmission sleeve 12 is therefore equipped with the introducing funnel 15.

When, for example, aluminum is used for the welding, it is not important where the welding wire is contacted in the contact tube 1. The embodiment illustrated in FIG. 1 is particularly suitable for welding aluminum because the contacting by means of the current transmission sleeve 12 already takes place at the entrance 6 of the contact tube 1. As a result of the large axial length of the guiding sleeve 11, a particularly precise alignment and guidance of the welding wire by means of the guiding sleeve 11 can be achieved. Because of the large dimension of the guiding sleeve 11, the latter is subjected to only relative small stress in this case, whereby a particularly long service life is achieved for the contact tube 1.

In the FIG. 1 embodiment the cross-section or the diameter of the opening 10 in the mouth area 7 corresponds approximately to the cross-section or the diameter of the passage 13 in the guiding sleeve 11. Correspondingly, an axial front face of the guiding sleeve 11 facing the exit 8 is overlapped radially toward the inside by the annular step 9 such that the opening 10 of the mouth area 7 closes off approximately flush at the passage 13 of the guiding sleeve 11. As a result of this construction, the guiding sleeve 11 is protected from spatters which may occur during the welding operation. This will be particularly advantageous if a ceramic material is used for the guiding sleeve 11 because the spatters adhere particularly well to a ceramic material, whereby the geometry of the passage 13 of the guiding sleeve 11 can change and thus its guiding characteristic.

A process of manufacturing the contact tube 1 according to the invention can take place as follows.

A receiving opening 5 is placed in a blank of the tube body 2 on the side assigned to the entrance 6. The receiving opening 5 is placed, for example, by means of a bore, so far in the tube body 2 that it does not completely penetrate the tube body 2 but that the mouth area 7 stays at the exit 8. In this case, before or after the placing of the receiving opening 5 in the mouth area 7, the opening 10 can be made, for example, by means of a bore.

After the placing of the receiving opening 5, the sleeves 11 and 12 can be pressed in a defined sequence—here, first, the guiding sleeve and then the current transmission sleeve 12—into the receiving opening 5.

In this case, the sleeves 11 and 12 may have been previously provided with their passages 13 and 14. Likewise, in the case of a special embodiment of this method, it may be provided that the passage opening 4 is placed in the sleeves 11 and 12 and optionally in the mouth area 7 only after the pressing-in of the sleeves 11 and 12.

In the embodiment according to FIG. 2, two guiding sleeves 11 are provided which are arranged on both sides of the current transmission sleeve 12. In this case, one of these two guide sleeves 11 is arranged at the entrance 6 and correspondingly contains the introducing funnel 15. In addition, the axial dimension of the guiding sleeve 22 assigned to the exit 8 is selected to be relatively small. In such an embodiment, the contacting of the welding wire takes place relatively close to the exit 8 so that this contact tube 11 is used in particular when steel is used for the welding.

In the embodiment according to FIG. 3, the current transmission sleeve 12 extends over a relatively large axial section of the receiving opening 5, while the guiding sleeve 11 takes up only a relatively small axial section.

In the embodiment according to FIG. 4, a current transmission sleeve 12 is arranged on both sides of the guiding sleeve 11, in this case, one of the current transmission sleeves 12 being assigned to the exit 8.

In the embodiment according to FIG. 5, two current transmission sleeves 12 and two guiding sleeves 11 respectively are placed in the receiving opening 5. The arrangement is alternating, in FIG. 5, one of the current transmission sleeves 12 being arranged at the exit 8.

In the embodiment according to FIG. 6, three guiding sleeves 11 and two current transmission sleeves 12 are pressed into the receiving opening 5, two guiding sleeves 11 respectively being arranged on both sides of one of the current transmission sleeves 12.

In the embodiment according to FIG. 8, as in the embodiment according to FIG. 5, two guiding sleeves 11 and two current transmission sleeves 12 respectively are pressed into the receiving opening 5. In contrast to the variant according to FIG. 5, however, in the case of FIG. 8, one of the guiding sleeves 11 is arranged at the exit 8.

It is clear that the embodiments illustrated in FIGS. 1 to 8 do not represent a complete listing of the possible variants of the present invention. However, it is indicated that, in the case of the contact tube according to the invention, while the tube body 2 remains basically the same, it is possible to construct the contact tube 1 in multiple manners as a result of the use of different sleeves 11, 12. For example, by way of the length and the thickness of the sleeves 11 and 12 as well as by way of the selection of their material, the contact tube 1 can be optimally adapted here to the respective application.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A contact tube for supplying current for a welding torch said contact tube comprising:
a tube body which contains a coaxial passage opening for a welding wire, the tube body also containing a receiving opening coaxial to the passage opening,
at least one current transmission sleeve inserted in said receiving opening, said current transmission sleeve having a material particularly suitable for transmitting current to the welding wire and containing a coaxial passage which forms an axial section of the passage opening; and
at least one guiding sleeve inserted into the receiving opening, which guiding sleeve consists of a material particularly suitable for guiding the welding wire and said guiding sleeve containing a coaxial passage which forms another axial section of the passage opening.

2. The contact tube according to claim 1, wherein the current transmission sleeve consists of metal graphite or brush material or of copper enriched with graphite or of a copper alloy enriched with graphite.

3. The contact tube according to claim 1, wherein the guiding sleeve consists of an electrically non-conductive ceramic material.

4. The contact tube according to claim 1, wherein, the tube body consists of copper or of a copper alloy or of aluminum or of an aluminum alloy.

5. The contact tube according to claim 1, wherein the receiving opening starts at the entrance of the welding wire and ends in front of a mouth area of the tube body containing the exit of the welding wire, this mouth area containing a central opening whose diameter is smaller than the diameter of the receiving opening and which forms an axial section of the passage opening.

6. The contact tube according to claim 5, wherein the diameter of the opening of the mouth area corresponds approximately to the diameter of the passage of the sleeve adjoining the latter.

7. The contact tube according to claim 1, wherein one of the at least one guiding sleeves is arranged closer to the exit of the welding wire than the current transmission sleeve.

8. The contact tube according to claim 1, wherein one guiding sleeve respectively is arranged on both sides of the current transmission sleeve.

9. The contact tube according to claim 1, wherein one of the sleeves is arranged at the entrance of the welding wire, the said one sleeve having an introducing funnel.

10. The contact tube according to claim 1, wherein one of the at least one guiding sleeves is arranged at the entrance of the welding wire.

11. A method of producing a contact tube having a tube body which contains a coaxial passage opening for a welding wire, the tube body also containing a receiving opening coaxial to the passage opening at least one current transmission sleeve inserted in said receiving opening, said current transmission sleeve having a material particularly suitable for transmitting current to the welding wire and containing a coaxial passage which forms an axial section of the passage opening; and at least one guiding sleeve inserted into the receiving opening, which guiding sleeve consists of a material particularly suitable for guiding the welding wire and said guiding sleeve containing a coaxial passage which forms another axial section of the passage opening; said method comprising the steps of:
placing the receiving opening in a blank of the tube body constructed as a solid body; and
pressing the sleeves in a defined sequence into the receiving opening.

12. The method according to claim 11, wherein the receiving opening is placed on the face side assigned to the entrance of the welding wire into the blank of the tube body such that the receiving opening does not completely penetrate the tube body but that a mouth area remains which is assigned to the exit of the welding wire, a central opening, which forms an axial section of the passage opening, being placed in this mouth area before or after the placing of the receiving opening.

13. The method according to claim 11, wherein the passage opening is placed in the sleeves and optionally in the mouth area only after the pressing-in of the sleeves.

14. The contact tube according to claim 2, wherein the guiding sleeve consists of an electrically non-conductive ceramic material.

15. The contact tube according to claim 2, wherein the tube body consists of copper or of a copper alloy or of aluminum or of an aluminum alloy.

16. The contact tube according to claim 3, wherein the tube body consists of copper or of a copper alloy or of aluminum or of an aluminum alloy.

17. The contact tube according to claim 2, wherein the receiving opening starts at the entrance of the welding wire and ends in front of a mouth area of the tube body containing the exit of the welding wire, this mouth area containing a central opening whose diameter is smaller than the diameter of the receiving opening and which forms an axial section of the passage opening.

18. The contact tube according to claim 3, wherein the receiving opening starts at the entrance of the welding wire and ends in front of a mouth area of the tube body containing the exit of the welding wire, this mouth area containing a central opening whose diameter is smaller than the diameter of the receiving opening and which forms an axial section of the passage opening.

19. The contact tube according to claim 4, wherein the receiving opening starts at the entrance of the welding wire and ends in front of a mouth area of the tube body containing the exit of the welding wire, this mouth area containing a central opening whose diameter is smaller than the diameter of the receiving opening and which forms an axial section of the passage opening.

20. The contact tube according to claim 2, wherein one of the at least one guiding sleeves is arranged closer to the exit of the welding wire than the current transmission sleeve.
